(19) United States
(12) Patent Application Publication
(10) Pub. No.: US 2015/0348433 A1
(43) Pub. Date: Dec. 3, 2015

(54) Systems, Methods, and Software for Enabling Automated, Interactive Assessment

(71) Applicant: Carnegie Mellon University, Pittsburgh, PA (US)

(72) Inventors: Wolfgang Gatterbauer, Pittsburgh, PA (US); Ramamoorthi Ravi, Pittsburgh, PA (US)

(21) Appl. No.: 14/726,418

(22) Filed: May 29, 2015

Related U.S. Application Data
(60) Provisional application No. 62/004,788, filed on May 29, 2014.

(51) Int. Cl. G09B 7/02

(52) U.S. Cl. CPC G09B 7/02

(57) ABSTRACT

Methods, system, and software that enables students to create high quality, automatically gradable questions without requiring any manual rating of questions, while at the same time aiding the learning of the students in each of their interactions with the system. The problem of determining the quality of student-submitted questions may be solved by automatically assigning discrimination scores to questions that indicate the extent to which successfully answering a question corresponds to overall learning achievement, e.g., total score on a set of questions. Students may then be rewarded for creating questions with high discrimination scores (as a proxy of high quality of the question) and/or correctly answering questions with high discrimination scores. A question bank of high-quality automatically gradable questions can be created that can be used in the same or future iterations of a course. Both creating the questions and taking the tests are valuable learning experiences for students.

### RELATED APPLICATION DATA

This application claims the benefit of priority of U.S. Provisional Patent Application Ser. No. 62/004,788, filed on May 29, 2014, and titled “A Method and System for Assessment Through Creating and Answering Questions,” which is incorporated by reference herein in its entirety.

### FIELD OF THE INVENTION

The present disclosure generally relates to the field of education. In particular, the present disclosure is directed to systems, methods, and software for enabling automated, interactive assessment.

### BACKGROUND OF THE INVENTION

In this era of Massive Open Online Courses (MOOCs), a key challenge in scaling education is the development of appropriate assessment vehicles that are goal-directed and provide targeted feedback. One of the key issues is the inability of the instructor to provide a sufficient number of such assessments, even if they are only simple question-answer pairs that can be automatically checked by a computer. Making a question bank that is relevant to the actual conduct of a course (and hence not simply drawn from a ready-made bank from a text book) and that is able to test the various learning outcomes is time consuming and involves much intellectual effort. Existing technology can alleviate assessment at scale only partially, e.g., by providing immediate feedback automatically. However, this ability depends on having good questions (i.e., those that are aligned with learning objectives, relevant to the dynamics of the current conduct of the course, appropriately matched with students' prior knowledge, and ideally amenable to automatic scoring) and a system that can deploy them at scale while gathering important data and providing feedback to the instructor about the student performance.

To summarize, there are three key challenges for instructors when teaching a large number of students. 1: Creating active learning experiences involves making high quality questions for the students to train on, which is a very time-consuming effort for the instructor. Similarly, creating goal-directed practice for the students is costly both in time and cognitive effort for the instructor. 2: Testing understanding is more critical than testing factual learning. Creating questions that do the former rather than the latter involves increased investment of time and effort. 3: Instructor time is valuable and best used in high-value activities that facilitate learning. Balancing the various activities of running the class, such as planning the topic flow and preparing and delivering lectures, with time-consuming assessment design, is vital to running an effective class.

An attractive feature of many popular textbooks is the convenience of well-prepared question-answer banks which are a set of various questions categorized both by type (multiple choice questions, fill-in-the-blanks, essay, etc.) and by difficulty and organized along the learning modules in the textbook. Such question banks can be integrated with existing learning management systems via learning technology integration (LTI) tools. However, these question banks are rarely adequate for a seasoned educator who will want to test specific aspects of the material that she emphasizes in her version of the course. In addition, the limited size of these test banks requires the instructor to make an important trade-off as to whether to use the most useful and interesting questions for tests or rather for self-directed learning by the students.

### SUMMARY OF THE INVENTION

Various methods presented in this disclosure increase learning efficiency of students by going from passive reading (“repeated study”) to “active retrieval practice” by generating interesting practice questions with given answers and automatic question checking. At the same time, it reduces the time for instructors to provide this experience outside of the classroom. One key insight is that, with the right design, both goals can be achieved. Concretely, the method and system are composed of creating interesting multiple choice questions (or “MCQs”), which serve as individual or group assignments to students. These created questions can then be used by other students to train themselves and by instructors to assess them. By posing creation of interesting MCQs as an individual or group assignment to students, the outcome of student work for assignments can be used for other productive purposes, namely increasing the learning of other students. An important aspect is that the quality of each question can be automatically determined by the ability of the question to separate high achieving students from low achieving students. Calculated quality scores may be exposed to students after the questions are taken. Required faculty interaction is reduced: The faculty member can assign a priori quality scores to some of the submitted questions for their educational value, which is less time consuming than creating interesting problems. Instructors can thus focus on seeding and guiding the process with appropriate interaction, guidance, examples, and declaring appropriate policies, while the students learn from (i) creating questions, (ii) taking questions, and (iii) comparing the question quality or discrimination scores of their own question against those of other students. Structured discourses between students can be supported. Students can also enhance their learning by (iv) suggesting improvements to various parts of a question and/or by (v) comparing various improvements to the same question by other students, e.g., by providing one or more types of feedback. Thus the system supports a structured discourse between students, centered around the tasks of creating, answering, and improving MCQs and/or other assessment items.

In one implementation, the present disclosure is directed to a method of enabling automated, interactive assessment of one or more of a plurality of untrusted individuals distributed across one or more networks with respect to one or more subjects, the method performed by an assessment management system. The method may include: displaying to one or more individuals of a first portion of the plurality of individuals a prompt for an assessment item including a specification related to the one or more subjects and one or more consistent responses and inconsistent responses to the specification; receiving at least two assessment items from one or more individuals of the first portion of the plurality of individuals; displaying to a first individual of a second portion of the plurality of individuals specifications of at least two assessment items received from at least one different individual of the plurality of individuals and prompts for responses to the specifications; receiving responses to the specifications from the first individual; displaying to a second individual of the second portion of the plurality of individuals specifications of at least two assessment items received from at least one different individual of the plurality of individuals and prompts for responses to the specifications, wherein the specifications of at least two assessment items displayed to the second individual are the specifications of at least two assessment items displayed to the first individual; receiving responses to the specifications from the second individual; determining an assessment result for each response received in response to each respective specification as a function of one or more of a consistent response and an inconsistent response to the respective specification received from the one or more individuals of the first portion of the plurality of individuals; determining an assessment item quality for each respective assessment item as a function of a correlation between the assessment result for each response received in response to the specification of the assessment item from the first and second individuals and assessment results for responses received in response to a specification of at least one different respective assessment item from the first and second individuals; and generating and storing an overall assessment of one or more individuals of the plurality of individuals with respect to the one or more subjects as a function of the assessment item quality for at least one assessment item either for which a specification was received from the individual or in response to the specification of which a response was received from the individual.

In another implementation, the present disclosure is directed to a method of automatedly generating a bank of assessment items through automated, interactive assessment of one or more of a plurality of untrusted individuals distributed across one or more networks with respect to one or more subjects, the method performed by an assessment management system. The method may include: displaying to one or more individuals of a first portion of the plurality of individuals a prompt for an assessment item including a specification related to the one or more subjects and one or more consistent responses and inconsistent responses to the assessment item; receiving at least two assessment items from one or more individuals of the first portion of the plurality of individuals; displaying to a first individual of a second portion of the plurality of individuals specifications of at least two assessment items received from at least one different individual of the plurality of individuals and prompts for responses to the specifications; receiving responses to the specifications from the first individual; displaying to a second individual of the second portion of the plurality of individuals specifications of at least two assessment items received from at least one different individual of the plurality of individuals and prompts for responses to the specifications, wherein the specifications of at least two assessment items displayed to the second individual are the specifications of at least two assessment items displayed to the first individual; receiving responses to the specifications from the second individual; determining an assessment result for each response received in response to each respective specification as a function of one or more of a consistent response and an inconsistent response to the respective specification received from the one or more individuals of the first portion of the plurality of individuals; determining an assessment item quality for each respective assessment item as a function of a correlation between the assessment result for each response received in response to the specification of the assessment item from the first and second individuals and assessment results for responses received in response to a specification of at least one different respective assessment item from the first and second individuals; and storing one or more assessment items related to the one or more subjects in a bank of assessment items as a function of the assessment item quality for each assessment item.

Either of the above methods and any other methods contained herein may also be performed by machine-executable instructions, which may be stored on one or more machine-readable storage mediums.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a flow diagram illustrating an exemplary method of enabling automated, interactive assessment of one or more individuals;

FIG. 2 is a flow diagram illustrating an exemplary method of automatedly generating a bank of assessment items through automated, interactive assessment of one or more individuals;

FIG. 3 is a high-level block diagram illustrating an exemplary assessment management system that may be used to implement one or more of the methods of FIGS. 1 and 2;

FIG. 4 is a visual representation of exemplary methods of calculating qualities of assessment items, weights for portions of assessment items, and/or scores for individuals as a function of student activities via various dependencies and intertwined cycles;

FIG. 5 is a visual representation of further exemplary methods of calculating weights for portions of assessment items and/or scores for individuals as a function of further student activities; and

FIG. 6 is a diagrammatic view of a computing system suitable for use in executing aspects of the present invention.

### DETAILED DESCRIPTION OF THE PREFERRED EMBODIMENTS

In some aspects, the present disclosure is directed to systems, methods, and software for enabling automated, interactive assessment of one or more individuals. For example, various aspects of the present disclosure can be used to automatedly assess one or more students, patients, or other individuals with respect to one or more subjects, such as an academic subject or a medical condition, among others. Although the disclosure focuses primarily on a particular embodiment wherein students are automatedly assessed by prompting them for assessment items comprising stems of multiple choice questions (or “MCQs”) as assessment item specifications and one or more corresponding answers to such multiple choice questions as consistent, or correct, and inconsistent, or incorrect, responses to the MCQs and then having the students answer assessment items provided by various other students, the present disclosure is not limited to such implementations.

For example, groups of patients or other individuals may utilize systems, methods, and software of the present disclosure to automatedly assess themselves, e.g., by separating themselves into two distinct groups, one of which including individuals who may have an ailment and another including individuals who may not, with respect to a particular medical or other type of condition. In various particular embodiments described in detail herein, teachers or other educators or educational services may interact with systems and software of the present disclosure to complement or otherwise direct the actions of the individuals to be assessed, for example by providing assessment items that are known to be of high quality, by answering MCQs provided by students, or by selecting portions of assessment items or particular students. However, in some embodiments, doctors or other healthcare providers may interact with systems and software of the present disclosure in order to complement or otherwise direct the actions of the individuals, such as patients or other individuals, to be assessed. For example, a doctor may review MCQs or other portions of assessment items provided by one or more individuals suffering from depression in much the same way that a teacher may review MCQs or other portions of assessment items provided by one or more students. In general, the methods, systems, and software of the present disclosure are not limited to any particular field, but rather can be used to assess any individuals regarding any type of subject provided that assessment items can be provided related to that subject.

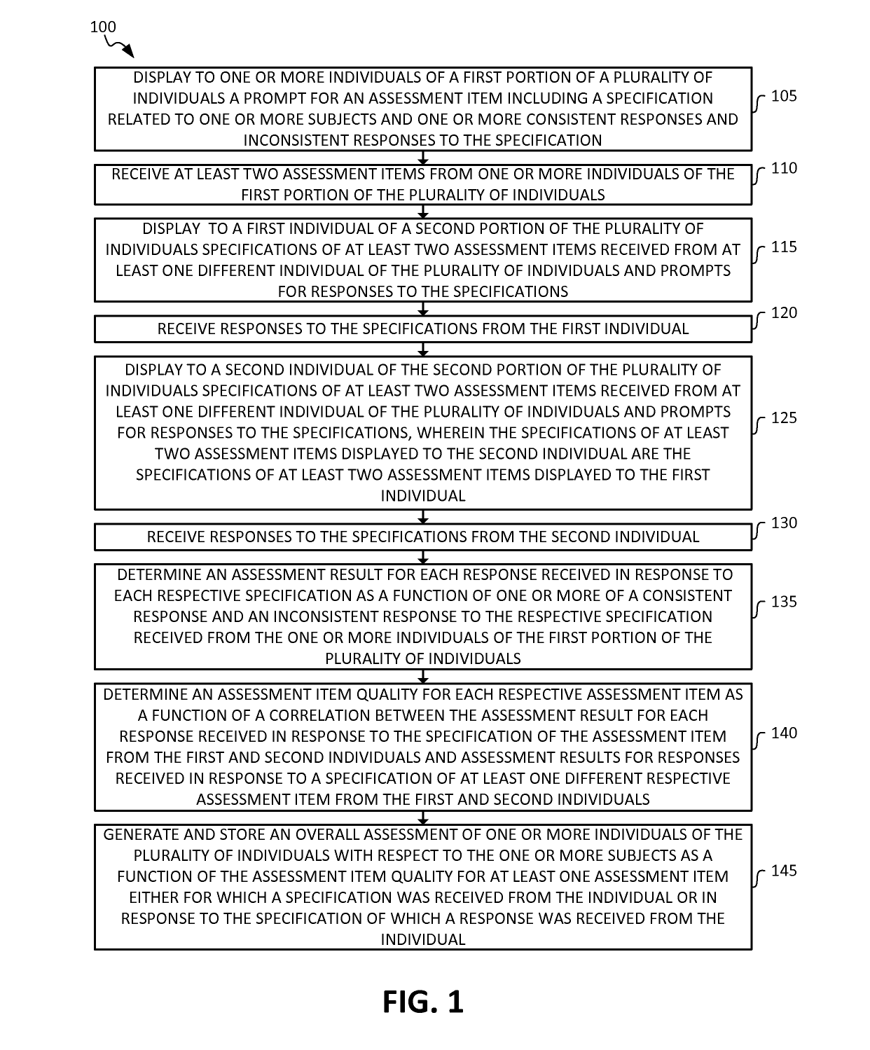

Referring now to the drawings, FIG. 1 illustrates an exemplary method 100 of enabling automated, interactive assessment of one or more of a plurality of untrusted individuals distributed across one or more networks with respect to one or more subjects, the method performed by an assessment management system, which may be a learning management system or other system, as described further herein. The term “untrusted” is used herein to refer to individuals who are not particularly well-versed in the subject matter with respect to which they may be assessed, such as students, patients, or other crowdsourced assessment item providers. On the other hand, “trusted” individuals are those individuals who are well-versed in the subject matter, such as doctors, teachers or other educators, such as teaching assistants, and educational services, among others.

Step 105 includes displaying to one or more individuals of a first portion of the plurality of individuals a prompt for an assessment item including a specification related to the one or more subjects and one or more consistent responses and inconsistent responses to the specification. This may involve, for example, displaying a graphical prompt for a MCQ including its stem, a correct answer, and several incorrect answers to the MCQ stem on a graphical user interface (GUI) to an untrusted individual. By enabling untrusted individuals to provide such assessment items, trusted individuals, such as one or more teachers or doctors, among others, can merely stand by while the untrusted individuals utilize the system or interact with the system as much as they like or feel is necessary. In some embodiments, untrusted individuals may be guided through the process of utilizing the system, e.g., by a teacher or automatically by the system itself, such that, for example, they must provide a certain number, e.g., one or two, of assessment items by a certain date and answer a certain number, e.g., five or ten, by another date.

Step 110 includes receiving at least two assessment items from one or more individuals of the first portion of the plurality of individuals. This may involve receiving two assessment items from a single individual or one assessment item from each of two individuals. Notably, although only two assessment items are strictly required to perform various aspects of the present disclosure, those of ordinary skill in the art will understand, after reading this disclosure in its entirety, that having more than two assessment items with which to assess students increases the usefulness of various aspects disclosed herein.

Step 115 includes displaying to a first individual of a second portion of the plurality of individuals specifications of at least two assessment items received from at least one different individual of the plurality of individuals and prompts for responses to the specifications. For example, this may entail displaying two MCQ stems and two or more answers or responses to the MCQs to a student and requesting that the student select a response for each MCQ. However, in some embodiments, this may include displaying an open-ended but preferably automatically gradable question to a student and prompting the student to provide a response to the question by typing in or otherwise manually providing a response. Although two portions of the plurality of individuals are described herein, these portions may include some or all of the same students in some embodiments. Examples of automatically gradable questions also include calculated formulae, calculated numeric results, either/or questions, matching questions, multiple answer questions, ordering questions, and true/false questions, although it is emphasized that other types of automatically gradable questions are certainly usable in the context of aspects of the present disclosure. Step 120 includes receiving responses to the specifications from the first individual.

Similarly to step 115, step 125 includes displaying to a second individual of the second portion of the plurality of individuals specifications of at least two assessment items received from at least one different individual of the plurality of individuals and prompts for responses to the specifications, wherein the specifications of at least two assessment items displayed to the second individual are the specifications of at least two assessment items displayed to the first individual. And similarly to step 120, step 130 includes receiving responses to the specifications from the second individual. Notably, although only two individuals in the second portion of the plurality of individuals and one individual in the first portion of the plurality of individuals are required, the more individuals who utilize the system by providing assessment items, providing responses to assessment items, rating various aspects of assessment items (e.g., by giving various responses and feedback to the assessment system), etc., the better the system will be able to assess each individual and each assessment item.

Step 135 includes determining an assessment result for each response received in response to each respective specification as a function of one or more of a consistent response and an inconsistent response to the respective specification received from the one or more individuals of the first portion of the plurality of individuals. Here, an “assessment result” refers to a correspondence between a response provided by an individual and whether that response is consistent, or correct, or inconsistent, or incorrect, with the specification of the assessment item. For example, if a student responds incorrectly to a MCQ, then the assessment result may indicate that fact and may also include which incorrect response was given.

Step 140 includes determining an assessment item quality for each respective assessment item as a function of a correlation between the assessment result for each response received in response to the specification of the assessment item from the first and second individuals and assessment results for responses received in response to a specification of at least one different respective assessment item from the first and second individuals. For example, by comparing assessment results for two students who have both provided responses to two specifications of assessment items, it is possible, in at least some situations, to determine a quality, e.g., an estimated quality, for the assessment items.

Step 145 includes generating and storing an overall assessment of one or more individuals of the plurality of individuals with respect to the one or more subjects as a function of the assessment item quality for at least one assessment item either for which a specification was received from the individual or in response to the specification of which a response was received from the individual. For example, if a student provides an assessment item that two other students both respond to incorrectly or correctly, then that assessment item may be of a lower quality than an assessment item that the two other students respond to differently (assuming that, for example, the better, or more studious and/or higher scoring, student provided a correct answer). By determining an assessment item quality, not only can students who respond to such assessment items be rated in some way, but, importantly, the student who provided the assessment item can also be rated.

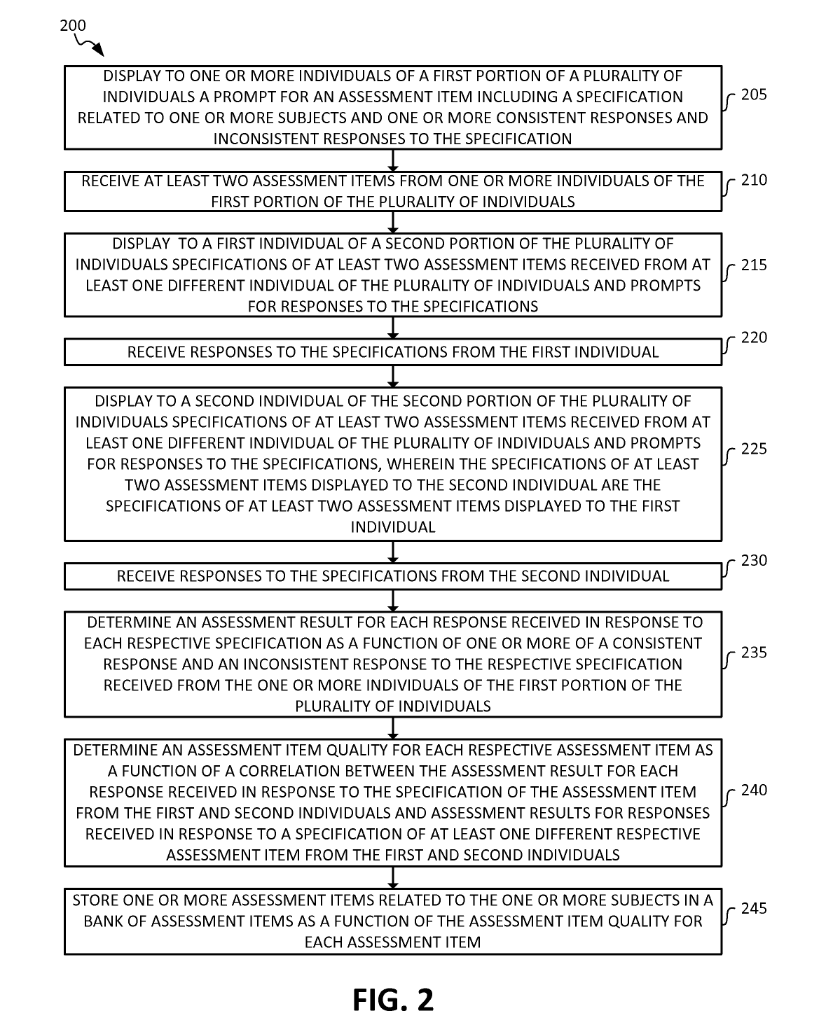

Turning now to FIG. 2, an exemplary method 200 of automatedly generating a bank of assessment items through automated, interactive assessment of one or more of a plurality of untrusted individuals distributed across one or more networks with respect to one or more subjects is illustrated, the method being performed by an assessment management system. Although method 100 and method 200 are similar and, in fact, complement one another, they have different basic functions: method 100 is directed primarily to generating assessments of students, while method 200 is directed primarily to generating a bank of assessment items. Despite these different basic functions, the majority of steps of method 200, and namely steps 205, 210, 215, 220, 225, 230, 235, and 240, are identical to those of method 100, and so only step 245 will be described in further detail.

Step 245 of method 200 includes storing one or more assessment items related to the one or more subjects in a bank of assessment items as a function of the assessment item quality for each assessment item. By determining qualities for assessment items, lower quality assessment items can be discarded or only temporarily retained while higher quality assessment items can be stored in a bank of known good assessment items such that they can be used to assess individuals over time. For example, a group of students may generate a bank of assessment items in one semester, and that bank may then be used to source known good assessment items for use in assessing students in subsequent semesters. Similarly, one or both sections of students in different sections of the same course may be assessed using a bank of assessment items generated by students of one or both sections or past sections.

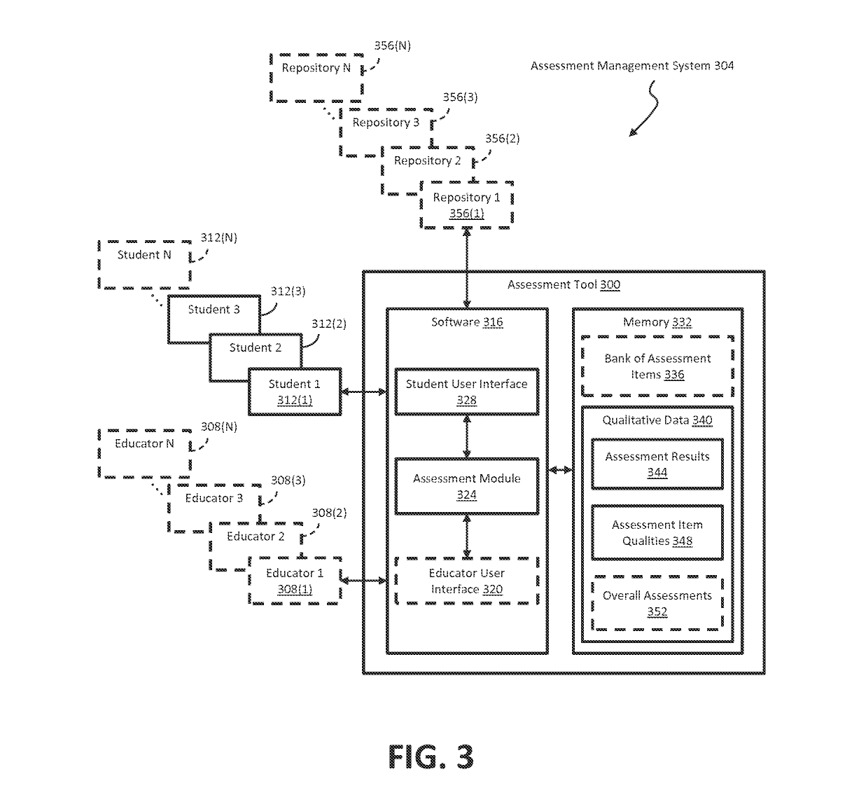

Before describing additional and alternative embodiments of methods 100 and 200, a particular assessment management system and assessment tool will be described with reference to FIG. 3 in order to provide an exemplary context in which the methods may be implemented.

Referring to FIG. 3, an assessment tool 300 may play a central role in an assessment management system 304, which may include zero to many educators 308(1) to 308(N), such as “Educator 1” 308(1), “Educator 2” 308(2), and “Educator 3” 308(3), and up to any number of educators (designated by “Educator N” 308(N)) who may utilize assessment tool 300 to generate assessments for students and/or crowdsource assessment items and associated responses, for example by performing methods like method 100 of FIG. 1 and/or method 200 of FIG. 2. As a particular non-limiting example, educators 308(1) to 308(N) may comprise one or more teachers, teaching assistants, and/or educational services, among others. Assessment management system 304 may additionally or alternatively include three or more students 312(1) to 312(N), such as “Student 1” 312(1), “Student 2” 312(2), and “Student 3” 312(3), and up to any number of students (designated by “Student N” 312(N)). In various embodiments, assessment tool 300 is configured to allow one or more educators 308(1) to 308(N) and/or students 312(1) to 312(N) to interact with the assessment tool to generate assessments for students and/or crowdsource a bank of assessment items. Notably, educators 308(1) to 308(N) may oversee one or several different courses and sections of such courses; in general, different courses may, in some situations, be less suitable for applying aspects of the present disclosure than separate sections of the same courses. However, in some embodiments, such as where one or more sections of a more advanced course prepare questions for one or more sections of a less advanced course, aspects of the present disclosure can be utilized to their full effect.

In the context of exemplary assessment tool 300 of FIG. 3, aspects of the present invention are implemented in software 316. One or more “blocks” of computer program code, or modules of code, may be included in software 316. It is to be understood that separate “modules” are described herein for ease of illustration and discussion. As a practical matter, the program code instantiating the invention could be organized in any one of a number of well-known manners to provide the functions described. While it is possible that separate code modules could be created to achieve the separate functions described, that is not required. So while various modules of the program of the invention are described separately, in practice the actual modules of code instantiating the functions described for those separate modules could be intermingled; they do not have to be separate and independent sequences of code.

Here, software 316 includes an educator user interface 320, which educators may access either directly by interacting with device 300 or indirectly (e.g., via an appropriately configured client, not shown), an assessment module 324 for generating assessments for students and/or crowdsourcing a bank of assessment items as a function of inputs provided by one or more educators 308(1) to 308(N) and/or students 312(1) to 312(N), and a student user interface 328, which students may access either directly by interacting with device 300 or indirectly (e.g., via an appropriately configured client, not shown). In some embodiments, educator user interface 320 and student user interface 328 may be the same interface.

Educator user interface 320 may provide a GUI operable to allow one or more educators 308(1) to 308(N) to provide one or more assessment items, responses to one or more assessment items, and/or feedback to assessment tool 300 and/or to use the assessment tool to generate assessments for students 312(1) to 312(N) and/or crowdsource a bank of assessment items. Additionally or alternatively, educator user interface 320 may comprise a software interface allowing each educator 308(1) to 308(N) to utilize in-house software or separate clients, in some embodiments with custom interfaces, to interact with assessment tool 300. In some embodiments, educator user interface 320 may allow assessment tool 300 to automatedly transmit and/or retrieve information from one or more educators 308(1) to 308(N), as such may be required or desirable for assessing students and/or crowdsourcing a bank of assessment items. In some embodiments, educators 308(1) to 308(N) can associate or dissociate courses, sections of courses, and/or students with themselves or other educators. Student user interface 328 may function in much the same way as educator interface 320, with the exception that the student user interface may have fewer and/or different functionalities specific to students. For example, students may be able to sign up for courses, but they may not be able to register other students for those courses or remove other students from those courses. Those of ordinary skill in the art will understand, after reading this disclosure in its entirety, that educator user interface 320 and student user interface 328 may be designed in any of a number of different ways known in the user interface and educational arts.

Assessment module 324 may generate assessments for students and/or crowdsource a bank of assessment items, for example by performing a method like that of FIG. 1 and/or FIG. 2. In doing so, assessment module 324 may interface with educator user interface 320 and/or student user interface 328 in order to collect information that may be necessary to perform its functions (e.g., by collecting assessment items, associated responses, feedback, etc., from students and/or educators).

Assessment tool 300 may also include a memory 332 that holds and/or stores a variety of information, including, but not limited to, a bank of assessment items 336 and/or qualitative data 340. As shown, qualitative data 340 may include assessment results 344, assessment item qualities 348, and, optionally, overall assessments 352, which may comprise an overall rating, score, or grade for one or more individuals. To be clear, in some embodiments, qualitative data 340 may only be qualitative in the sense that it contains quantitative data related to qualities of assessment items and/or individuals; however, in other embodiments the qualitative data may additionally or alternatively be qualitative in more than just that sense.

In some embodiments, bank of assessment items 336 may be provided by a user, such as one or more of educators 308(1) to 308(N) and/or students 312(1) to 312(N), included in assessment tool 300 as a factory default, and/or received or retrieved from a third-party service. In some embodiments, bank of assessment items 336 may contain specifications of assessment items, responses to those assessment items, or both, although it is preferred that it contain both.

It is noted that although the various components of memory 332 are shown in FIG. 3 and described herein as separate components, they may be implemented as a single component or database or a plurality of components or databases. Memory 332 may represent any part or the entirety of the memory used by assessment tool 300 in providing its functionality. Depending upon the particular implementation at issue, memory 332 may be volatile memory, such as primary storage memory (e.g., random-access memory (RAM) or cache memory, etc.), non-volatile memory, such as secondary storage memory (e.g., a magnetic drive, optical drive, etc.), and any combination thereof and in any number of memory devices. In embodiments wherein assessment tool 300 undertakes a task of automatedly collecting and storing information from one or more educators 308(1) to 308(N), students 312(1) to 312(N) and/or third parties, memory 332 will typically be one or more secondary storage devices. In embodiments wherein assessment tool 300 collects data in real-time, such as from current activity in a separate third-party database or from data stores of one or more individual educators 308(1) to 308(N) in conjunction with performing its functions, memory 332 may only need to be a primary memory. Those skilled in the art will readily understand the types of memory(ies) needed for memory 332 for any particular instantiation of an assessment tool of the present invention.

As mentioned above, assessment tool 300 may interface with one or more third-party services or databases in order to update those services or databases with newly determined information and/or download new information, such as new assessment items for bank of assessment items 336, new assessment results 344, new assessment item qualities 348, and/or new overall assessments 352. Such third-party services and databases are represented in FIG. 3 as repositories 356(1) to 356(N), such as “Repository 1” 356(1), “Repository 2” 356(2), and “Repository 3” 356(3), and up to any number of repositories (designated by “Repository N” 356(N)). Repositories 356(1) to 356(N) may comprise one or more centralized and/or decentralized databases or services provided by one or more individuals or organizations, such as particular teachers, teaching assistants, groups, universities, and/or educational services, among others. Assessment tool 300 may include further user interfaces (not shown) to enable communication with one or more repositories 356(1) to 356(N).

For the sake of completeness, it is noted that the unlabeled arrows in FIG. 3 represent temporary and/or permanent data connections that enable data communication between various components of assessment tool 300. These connections may be implemented in the form of, for example, data buses, Internet connections, local network connections, and/or any other connections between electronic devices or portions of one or more devices. Further, the system can use information from an existing learning management system, such as which students are registered for which courses, sections, or educators. For example, learning technology interoperability may be utlilized to enable such uses, although any of a variety of other methods may be used, such as generic application programming interfaces or other means for interfacing with existing learning management systems known in the educational arts or communications arts. Further, one or more portions of assessment management system 304 may reside or otherwise interface with cloud computing systems. Generally, there is no limitation on how the elements of assessment management system 304 are arranged structurally or otherwise provided that they can perform or provide one or more methods or functions of the present disclosure.

Referring again to FIGS. 1 and 2, and also FIG. 3, assessment tool 300 can be used to perform one or more steps of methods 100 and 200. For example, using one or more of the various elements of assessment management system 304 described above, the assessment tool may prompt students 312(1) to 312(N) and/or educators 308(1) to 308(N) for assessment items via assessment module 324, optionally collect assessment items in bank of assessment items 336, generate assessment results 344 and assessment item qualities 348 via the assessment module, and otherwise enable various students, educators, and/or one or more repositories 356(1) to 356(N) to assist the students or otherwise accelerate the education of the students. As noted above, students, educators, courses, and sections of courses may be linked to one another in assessment tool 300; for example, these links may be established automatically or automatedly by the assessment tool, optionally by interfacing with one or more other systems, or configured manually by one or more students, educators, or educational services, among others. Educators and/or trusted or partially trusted students (e.g., students who have high grade point averages or who have otherwise proven to have good study habits relative to other students in the estimation of an educator or automated routines executed by assessment module 324), and even untrusted individuals in some embodiments, may then provide feedback, optionally in the form of some type of discussion, to assessment tool 300 such that it can appropriately improve and/or modify one or more aspects of bank of assessment items 336, assessment results 344, assessment item qualities 348, and/or overall assessments 352. Such discussions may be guided or unguided, but the nature of MCQs and other automatically gradable assessment items provides for an excellent way to determine whether a given MCQ or other automatically gradable assessment item is of high or low quality: a discrimination score. Students can suggest improvements and other students can vote on them, but the ultimate test is how well the resulting questions actually perform.

In some embodiments, confidence levels of various determinations made by assessment module 324 can be calculated by the assessment module, such as a confidence level of an assessment item quality for an assessment item, a confidence level of an assessment result, a confidence level of a feedback quality for feedback, and a confidence level of an overall assessment. As discussed further herein, assessment module 324 may use confidence levels such as these to calculate more accurate ratings for individuals, qualities for assessment items, etc. Further, assessment module 324 may use such confidence levels to determine how to best make use of a trusted individual's availability, such as by interfacing with a digital calendar or schedule for the individual or by the individual specifying, either directly or indirectly, to assessment tool 300 a limited amount of time, blocks of time, or a number of items they have time to review. For example, if an assessment item has a very high quality and that quality has a very high confidence, it may be unnecessary to present that assessment item to a trusted individual for feedback; however, in some embodiments, it may be advantageous to do so, particularly in the early stages of collecting assessment items, in order to ensure that the very high confidence is not merely a fluke.

Having established general facets of the present disclosure, various embodiments, applications, and alternatives will now be presented. For example, in some embodiments, the system may comprise a semi-automatic question quality learning algorithm that uses student test scores, such as externally generated or imported test scores and/or test scores generated within the system, optionally with recursive updates, and an initial small set of default assessment of properly classified questions by the instructor whose quality is “propagated” to those students who answered them, and from there to other questions proposed by students. This system benefits from a virtuous cycle where good initial instructor-provided test questions and prior high quality assessment in the system (from the instructor or a rated textbook question bank) allow the dynamically augmented system to become self-improving over time.

In some embodiments, instructors can provide seed question-answer pairs from existing book question-answer banks together with default quality scores. In another embodiment, instructors assess default quality scores for a subset of the question-answer pairs provided by students. The student-submitted question quality is a function of the ability of a question to discriminate high achieving students from low achieving students. It is thus indirectly determined based on the performance of students on questions for which the question quality is known, in an iterative way. The users with top creation quality, the users who performed best on answering the weighted questions, and the question-answer pairs with highest quality or discrimination scores are determined.

Various embodiments may include one or more of the following functions. Although these functions and other aspects of the present disclosure are presented in a particular order, they need not necessarily be performed in any particular order and in most cases can be used partially, substantially, or wholly independently of one another.

1. Creating question-answer pairs: As part of their homework assignments, students may be required to create MCQs. For instance, students may be assigned to random groups of three or four students and asked to post two MCQs per group by a first assigned deadline. Students may then be asked to come up with MCQs that make a reader think more deeply about some of the main topics of the class and are more likely to be correctly answered by students who understood the class material. The instructor may choose to give examples of good MCQs together with discrimination scores and justification. Students may be asked to provide additional justification for their choices of correct and wrong answers and reference for their content.

2. Taking question-answer pairs. As part of their assignments, students may also take (e.g., answer or respond to) previously proposed questions by other students. Students may also optionally propose a suggestion to improve the question-answer pair (i.e., some aspect of the assessment item).

3. Bootstrapping ground truth by instructor. Instructors can provide seed interaction at various steps in the process. Instructors may also insert separately created MCQs together with quality scores. Instructors may also assign specific a priori quality scores for student-submitted questions. These “instructor ratings” serve as approximation of the ground truth and there is an interesting interaction between the instructor a priori scores and later quality scores. An instructor may include very good questions that set a standard for other students to emulate or that serve as reference for determining discrimination scores for student-submitted questions.

4. Automatic Evaluation. At least two separate types of performance can be evaluated with this system: (a) “testing score”: How well does the student perform on quiz questions and hence on the topics on which the quiz is based? and (b) “creation score”: How good are the questions the student creates? Each of those two types measures a different dimension of learning. An appropriate incentive scheme will use a clever mix of these two dimensions, together with appropriate metrics for each dimension, and a clever algorithm that calculates these metrics dynamically. The top high achieving students will be announced in class, and may be separated into top question creators and top question raters. The top creators may be determined as the groups with the top rated questions by the instructors or the questions that are most indicative of (e.g., correlated with) overall student achievements among the students who answer them. The automatic evaluation algorithm may also suggest particular tasks for faculty (or students) to perform to maximize the confidence in the final ranking or assessment of questions and students. Students can see the determined question quality of their submitted questions and optionally, those of other questions.

5. Iterations: In one instantiation, students are able to improve their previously submitted MCQs for another round of reviews. Students amend and improve their previous MCQs based on the detailed quality assessment scores received (e.g., detailed scores for the correct answer and each discriminator) and optional improvements or suggestions by question takers. A newly chosen set of students may take the same question again, allowing the system to compare the question's quality before and after. Step (5) may be repeated a specified number of times, forming a cycle of learning while increasing the quality of questions.

6. Self-Training and Testing. High-quality questions are deemed to be “curated” and can be used for both valuable active retrieval practice for students and actual quiz and test questions. With the availability of a larger bank, students can choose to attempt to solve more questions of other students. This allows students to engage in more active retrieval practice of the class content and thus have a better way of learning the class content. The question bank will also serve as a basis for evaluating students on the final exam.

In some embodiments, question-answer pairs usually consist of four con-ceptual parts: 1) question: a question posed in textual, visual, or other form, also referred to as a question stem or specification of an assessment item; 2) solution: a correct answer to the question; 3) choices: an optional placeholder of one or several choices that allows a user to construct an answer to the question, optionally including distractors that are incorrect but tend to discriminate between the abilities or knowledge of students; and 4) explanation: an optional explanation for the choice of answer for the question.

In one example, the question and answer are mandatory, while choice and explanation are optional. Some forms of question-answer pairs allow a choice provided by a user to be automatically compared against the answer and, thus, the user's response may be automatically checked for correctness. These sorts of questions are considered to be automatically verifiable. A widely-used example is a MCQ where the question is commonly posed as a text and increasingly often together with a visual depiction, multiple choices as possible answers from which a user can pick one or several correct ones, and the answer which is a subset of the choices provided. Another automatically verifiable question-answer is a question that asks the user to rank a set of answers correctly. Various other automatically-graded question-answer pairs can be imagined (e.g., choose all that apply, true or false, numeric questions, Likert scale questions, etc.). A set of question-answer pairs is called a question-answer bank.

In one example, the system is built as an LTI (Learning Tools Interoperability) tool whose core services are hosted on cloud-based servers or platforms. This allows the system to be deployed as a simple extension to existing learning management systems. This provides visibility, optimal integration, and minimal disruption for existing classes. In one example, a light-weight tool is created on top of the existing infrastructure that adds the previously described functions to any existing class. In another example, the system allows other researchers to easily adapt various process aspects (e.g., the number of students answering or taking a MCQ or the number and description of dimensions along which MCQs are improved or labeled as being good or bad), easily deploy alternative algorithms and incentive structures (e.g., the blending of the final grade based on higher weights for creating or suggesting improvements for MCQs), and to easily import and export MCQs and meta-data. Finally, methods can be developed by which the tool can be deployed in the context of existing MOOCs so that it serves as a key enabler of better assessment of online students.

A basic consideration in evaluating the performance of a normative test item is the degree to which the item discriminates between high achieving students and low achieving students. These scores are known as discrimination indexes (scores) in the learning community. Literally dozens of indices have been developed to express the discriminating ability of test items. Most empirical studies have shown that nearly identical sets of items are selected regardless of the indices of discrimination used. A common conclusion is to use the index which is the easiest to compute and interpret. A key insight of this disclosure is that the quality of student-submitted questions can be automatically assessed (without any required ratings) by a question's ability to discriminate between high achieving students and low achieving student. A discrimination index for a question-answer pair indicates the extent to which successfully answering a question-answer pair corresponds to overall learning achievement, i.e. it is a measure of correlation between how well users perform on the question and some outside achievement scale (e.g., all other questions weighted by their quality). Questions with low or negative discrimination index are most likely not good questions. Through various aspects of the present disclosure, students who attempt to answer those questions and don't provide the correct answer are not penalized for incorrectly answering it, but rather the creator of the questions is. One typical approximation of overall learning achievement is success on a whole test, i.e. a set of multiple question-answer pairs. One often used measure is the Pearson product-moment correlation coefficient (of which the point-biserial correlation coefficient is a special case) that measures the correlation between answering the particular question-answer pair correctly and the total score on the overall test.

### Various Particular Aspects of the Present Disclosure

A method and system for teaching and assessing students with minimal effort by instructors. In some embodiments, a method asks users to provide automatically verifiable question-answer pairs. Each of the question-answer pairs is provided to a chosen set of multiple users, who are requested to supply the correct answer. The quality of student-submitted question-answer pairs are then assessed by the extent to which successfully answering the student-submitted questions corresponds to overall learning achievement, e.g., to an overall higher test score on a larger set of questions. The performance of students is then assessed as a function of the quality of the question submitted by the student and the test score weighted by the quality of each question. In some embodiments, the performance of students and the quality of questions are determined in an interactive and/or iterative way. In some embodiments, questions with top quality scores can be added to a question-answer bank for later testing purposes.

In some embodiments, aspects of the present disclosure comprise: gathering a plurality of question-answer pairs from a set of users connected to a data communication network; providing a plurality of question-answer pairs to a set of users connected to a data communication network; receiving via the data communication network a plurality of chosen answers associated with each of the plurality of question-answer pairs; determining, using one or more processors, a test-taking score for each user; determining, using one or more processors, a discrimination index for each gathered question; determining, using one or more processors, a weight for each gathered question as a function of its discrimination index; determining, using one or more processors, an overall assessment of each user as a function of the discrimination index of the question created by same user and the test taking score of same user; determining, using one or more processors, an assessment of each user as a combination of the discrimination score of the questions created by that user and the weighted test-taking score of that user.

In an extension of the embodiment, the test-taking scores of students, the discrimination scores of questions, and the quality scores of questions are calculated as interdependent functions of each other (in a consistent and interactive and/or iterative fashion). In another extension of the embodiment, the quality scores and discrimination indexes of questions are identical. In yet another extension, instructors also provide high-quality question-answer pairs, and discrimination scores for student-submitted question-answer pairs are assessed by the extent to which successfully answering the student-submitted questions correlates with successfully answering the faculty-submitted questions.

In yet another extension, an index of discriminating efficiency is used instead of an index of discrimination (discrimination efficiency is the index of discrimination divided by the maximum discrimination). In yet another extension, students can see the discrimination indexes for each of the distractors of their own or other questions and learn from common errors of other students. This may allow students to rethink their created question and improve it before giving it to yet other students to answer it in a next iteration. Notably, two exemplary types of iterations can be used: iterations used for calculating something and iterations through which questions get improved.

### 1. AN EXAMPLE EMBODIMENT

Consider a course with one instructor, m students iε[m]={1, 2, . . . , m}, and weekly assignments. Each such assignment focuses on a given subject and consists of several assignment “parts” which are grouped into several assignment “phases.”

### 1.1 Assignment Parts

(1) Create part. Each student i submits n_{c}(i) MCQs. A question consists of several question parts: a question stem, one specified correct answer and several incorrect answers (also called distractors). p(j) may be used for the number of question parts and a(j) for the number of answers for question j. For example, a question j with a(j)=4 answers, has 3 distractors and p(j)=5 parts. The create assignment part results in n=Σᵢn_{c}(i) different questions. An n-dimensional vector i_{c} may be used where an entry i_{c}(j) refers to the student who created question j.

(2) Answer part. Each student i answers a subset of nₐ(i) questions (that were not previously created by the respective student) by selecting, for each question j they take or respond to, one of the a(j) provided answers. The subset of questions can be assigned to students in various ways, e.g., randomly or with specific objectives functions in mind. One natural objective is to have each question be answered by a most similar number of students.

The set of questions answered by each student as well as the question answers selected by each student can be recorded in a [m×n>maxⱼ a(j)]-dimensional answer tensor A where A(i, j, k)ε{−1, 0, +1} is +1 if student i selected answer k of question j, or −1 if the student saw this answer but did not select it, or 0 if the question answer does not exist or the question was not shown to the student. In the following simplification, let A be the [m×n]-dimensional answer matrix for which entry A(i, j)ε{−1, 0, +1} is +1 if student i selected the correct answer for question j, or −1 if the student selected an incorrect answer (i.e. a distractor), or 0 if the question was not shown to the student. In other words, A in contrast to A does not record which of the a(j)−1 distractors of a question j was selected by a student who did not select the correct answer. m(j) may be used for the number of students who answered question j.

(3) Improve part. Each student i is given a subset of nᵢ(i) questions created by other students to improve them by modifying, for each question j of the nᵢ(i) questions, the text in any of the p(j) parts of that question. Each such improvement of a part leads to a new question part version that is recorded in the system. v(j, k) may be used for the number of resulting versions for a given part k of a question j (including the original version). A tensor iᵢ may be used where an entry iᵢ(j, k, l) refers to the student who created a version l of part k for question j.

(4) Finalize part. Each student i is given a subset of n_{f}(i) questions to finalize: For each question j of the n_{f}(i) questions, and for each part k of the p(j) parts, the student is presented with a set of v_{f}(j, k, i) versions among the total v(j, k) versions of the respective part. For example, these different question part versions may be the result of a prior improvement part, and thus, one of which may be the original version provided by a creator. The student i now selects one of the v_{f}(j, k, i) versions for each part k among the p(j) parts for each question j to finalize it. For each question part k of question j, let m_{f}(j, k) be the number of students that finalized this part.

The set of question parts finalized by each student as well as the question part versions selected by each student can be recorded in a [n×maxⱼp(j)×m×max_{j,k} v(j, k)]-dimensional finalize tensor F where F(j, k, i, l) is +1 if student i selected version l for part k of question j, or −1 if the student saw this version but did not select it, or 0 if the version does not exist or was not shown to the student. In the following, a slightly different notation may be used to simplify the exposition by avoiding tensors. Also, let i in the following stand for the i-th student who finalizes a respective question part. The finalizations may be recorded for each part k of a question j in a [m_{f}(j, k)×v(j, k)]-dimensional matrix F_{j,k} where F_{j,k}(i, l) is +1 if student i selected version l, or −1 if the student saw this version but did not select it, or 0 if the version was not shown to the student.

### 1.2 Assignment Phases

The different parts of the assignment can be combined into various phases. For example, an assignment may consist of three different sequential phases:

(1) Create phase. This phase consists of a create assignment part, i.e., students create questions.

(2) Answer and Improve phase. This phase may comprise one or more answer and improve assignment parts. Students first answer several questions, and can afterwards improve the questions they answered.

(3) Answer and Finalize phase. Students first answer a question and can afterwards improve the same question. This can be repeated for several questions.

### 1.3 Assignment Goals

(1) Student scores (s). A first goal is to automatically assess the competence of each student. In other words, for each student i, a student assignment score s(i), or overall assessment, may be derived that represents the relative competence of the student as compared to other students in the class. Given the above suggested four assignment parts, this score will collectively represent the quality of the questions created by the student, the answers given by the student, and the improvements and finalizations made by the student.

(2) Question scores (q). In addition, the overall quality of each question j may be assessed with a question score q(j). This question score allows comparison of the relative quality across questions, and allows the best questions to be selected for future use, e.g., for testing purposes across a different set of students.

(3) Best question versions (w). The best question versions for each question may be sought (a “question version” is one choice of a “question part version” l for each question part k of a question j). The latter goal may be achieved by deriving a set of question part version weights w_{j,k}(l) that represent the relative quality of a version l of part k for question j, and then picking the top quality versions for each question part. For notational convenience, those weights are referred to as a weight tensor w where an entry w(j, k, l) is the weight of version l for part k of question j.

### 2. OVERALL APPROACH

The student scores, question scores, and question-part version weights are interdependent. Intuitively, student and question scores are dependent on each other in several ways: a good question is a better discriminator between good and bad students. In item response theory, the property of the question is known as its discrimination score. Also, a good student is both more likely to create good questions, and to answer a good question correctly.

To illustrate this idea with an example, assume that a student creates a completely meaningless question j (e.g., each of the a(j) answers is empty). A good student is not more likely to answer it correctly than a bad student. Thus, the student who created this question should not receive any points. In addition, whether a student answered the question “correctly” (according to the provided correct answer) should not have any impact on the answer score by a student. In other words, it makes sense that the question gets a weight of 0 (both for creation and for answering).

Knowing the quality of students allows better predictability of the quality of questions, plus the better question parts. Similarly, knowing the question qualities and the better questions parts allows determination of the good students.

Both student and question scores (and question version weights) are derived with a calculation that uses these mutual dependencies. Concretely, an iterative calculation may be calculated similar to expectation maximization (often used for webpage rankings) where the values are updated in each iteration. Iterations are repeated a fixed number of times or until the values have converged.

Three different types of scores (or weights) are tracked:

(1) s: the m-dimensional vector of student assignment scores: Since this score reflects all four activities of the student in the assignment, it is calculated as a function of all the individual scores a students receives for each of the four assignments.

s=ƒₛ(s_{c},sₐ,sᵢ,s_{f}) (1)

As an example implementation, a convex combination of four constituent scores may be written, one each for creation, answering, improvement and finalization.

s=μ_{c}s_{c}+μₐsₐ+μᵢsᵢ+μ_{f}s_{f} (2)

Note that in equation (2) above, the creation and answering score of a student depends on the quality weight of the questions created and answered by this student. This approach of determining the student scores as result of the weighted combination of activities leads to a transparent grading for the students and well-justified motivation for the question weights.

(2) q: the n-dimensional vector of question scores: This vector represents the quality of each question, which is also used in calculating the create and answer scores of each student. q_{d}, the n-dimensional vector of question discrimination scores may be computed: Entries in this vector represent the extent to which answering a particular question correlates with overall student competence.

(3) w_{j,k}: the v_{j,k}-dimensional vectors of question part version weights: One vector exists for each part k of a question j. Each such vector represents the relative weight (quality) among the versions of each question version part. Without loss of generality, these vectors may be normalized, thus Σₖw_{j,k}(l)=1. “Centered” versions of these vectors are defined as w′_{j,k} with

$${w}_{j , k}^{′} ( 𝓁 ) = {w}_{j , k} ( 𝓁 ) - \frac{1}{{υ}_{j , k}}$$

so that Σₖw′_{j,k}(l)=0. The reason is mathematical convenience as described below.

In the following, the calculation of these scores may be illustrated in a general iterative process that can be evaluated efficiently. In the beginning, the iteration may be started by initializing the question quality scores with “default question scores.” For example, q₀=1ₙ, i.e., the n-dimensional column vector with all ones, can be used as initial question scores.

q⁽⁰⁾←q₀

Similarly, the centered weights of each version of the same question part may be initialized with weights of zero:

w′_{j,k}⁽⁰⁾(l)←0

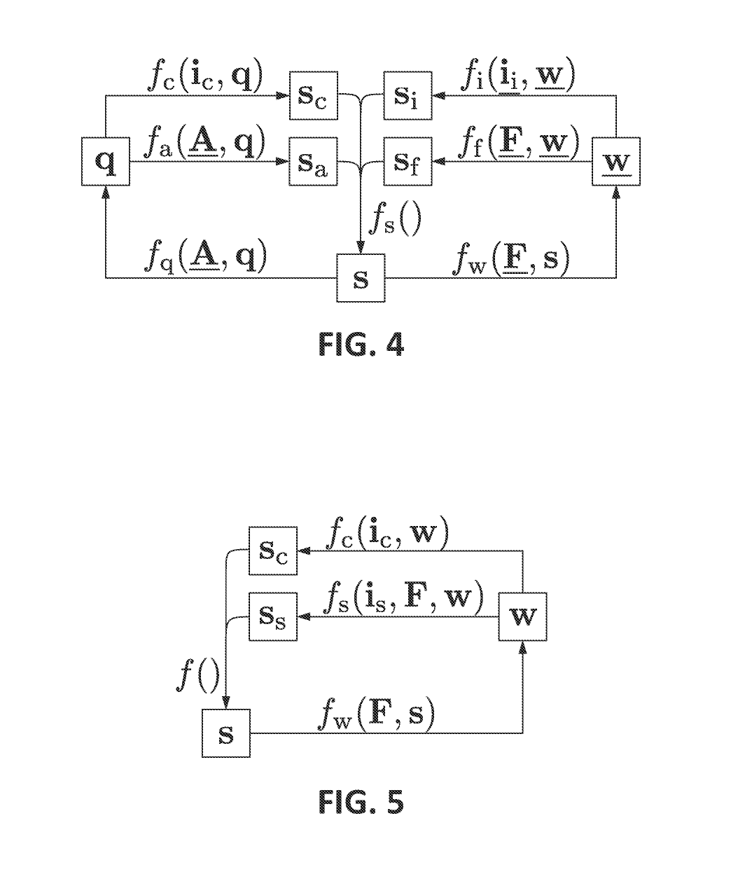

All question and student scores depend on each other. The following overview and FIG. 4 show how they depend on each other in the example implementation. In particular, FIG. 4 shows an example calculation of student assessment scores s by combining one or several “learning cycles”: (1) on the left: knowing q allows for calculation of s, and vice versa; (2) on the right: knowing w allows for the calculation of s, and vice versa; (3) additionally: knowing any entry of the displayed vector or tensor scores (q, s, s_{c}, sₐ, sᵢ, s_{f}, w) with higher certainty, allows for propagation of this seed knowledge, and thus also allows for calculation of the remaining variables with higher confidence.

$$create q {}^{{f}_{c} ( {i}_{c} , q )} {s}_{c} {}^{{f}_{s} ( )} s {}^{{f}_{q} ( \underline{A} , q )} q$$

$$answer q {}^{{f}_{a} ( \underline{A} , q )} {s}_{a} {}^{{f}_{s} ( )} s {}^{{f}_{q} ( \underline{A} , q )} q$$

$$improve \underline{w} {}^{{f}_{i} ( \underline{{i}_{i}} , \underline{w} )} {s}_{i} {}^{{f}_{s} ( )} s {}^{{f}_{w} ( \underline{F} , s )} \underline{w}$$

$$finalize \underline{w} {}^{{f}_{i} ( \underline{F} , \underline{w} )} {s}_{i} {}^{{f}_{s} ( )} s {}^{{f}_{w} ( \underline{F} , s )} \underline{w}$$

Notice that all individual steps of the cycles are coupled. In this example, they are coupled via the student scores.

### 2.1 Student Scores

Student scores can be a convex combination of the various activity scores of the students:

s^{(t)}←μ_{c}s_{c}^{(t)}+μₐsₐ^{(t)}+μᵢsᵢ^{(t)}+μ_{f}s_{f}^{(t)} (3)

To define each of the four components of the score, some notation may be used. Let α_{c}, αₐ, αᵢ and α_{f} denote constants representing per-unit points that may be assigned to students for creating, answering, improving and finalizing one question, respectively. Notice that the question weights of the previous iteration q^{(t-1)} will influence the definition of s_{c}(t) and Sₐ(t) as defined below.

(1) Create score. The create score for student i is defined as a function of the set of all the quality scores for questions j created by the student.

s_{c}^{(t)}(i)←ƒ_{c}({q^{(t-1)}(j)|j was created by i}) (4)

An example implementation is as follows:

$${s}_{c}^{( t )} ( i ) {\sum }_{j : created by i} ( {α}_{c} + {q}^{( t - 1 )} ( j ) ) \qquad ( 5 )$$

In other words, for each created question, a student receives the sum of the α_{c} constant and the quality score of the created question as points for that question.

(2) Answer score. The answer score for student i is defined as a function of the set of all the scores of questions answered by the student and how the student answered them.

sₐ^{(t)}(i)←ƒₐ(A,q) (6)

An example implementation is as follows:

$${s}_{a}^{( t )} ( i ) {\sum }_{j : answered by i} ( {α}_{a} + {q}^{( t - 1 )} ( j ) A ( i , j ) ) \qquad ( 7 )$$

In other words, for each correctly answered question, a student receives αₐ+q^{(t-1)}(j) points, and for each incorrectly answered question a student receives αₐ−q^{(t-1)}(j) points. Notably, points can be fractional or any real numbers, although other types of points could be used.

(3) Improve score. The improve score for student i is defined as a function of the question part version weights for each of the versions suggested by the student as possible improvements (or, in short, the versions “improved” by the student):

sᵢ^{(t)}(i)←ƒᵢ{w′_{j,k}^{(t-1)}(l)|l was improved by i}) (8)

An example implementation is as follows:

$${s}_{i}^{( t )} ( i ) ← {\sum }_{𝓁 : improved by i} ( {α}_{i} + {w}_{j , k}^{′ ( t - 1 )} ( 𝓁 ) ) \qquad ( 9 )$$

Notice that in the first iteration, w′_{j,k}⁽⁰⁾(l)=0.

(4) Finalize score. The finalize score for student i is defined as a function of the question part version weights the students have seen and selected from during the answer and finalize phase:

s_{f}^{(t)}(l)←ƒ_{f}(w′^{(t-1)},F) (10)

An example implementation is as follows:

$${s}_{f}^{( t )} ( i ) {\sum }_{𝓁 : finalized by i} ( {α}_{i} + {w}_{j , k}^{′ ( t - 1 )} ( 𝓁 ) ) \qquad ( 11 )$$

### 2.2 Question Scores

The question scores may be calculated as a function of the students who answer them (correctly or incorrectly) and their respective students scores:

q^{(t)}←ƒ_{q}(A,s^{(t)}) (12)

Discrimination scores. One way to calculate question scores is to lever-age any “discrimination score” of a question. Question discrimination scores are calculated in such a way as to maximize the chance that the student scores reflect the correct ordering of students:

q_{d}^{(t)}←ƒ_{d}(A,s^{(t)}) (13)

An example discrimination scores of a question is the Biserial correlation coefficient, which is derived from the Pearson product moment correlation coefficient. The Pearson product moment correlation coefficient between two series of variables x and y is defined as

$$r = ( \frac{{\sum }_{i} x ( i ) y ( i )}{m} - {μ}_{x} {μ}_{y} ) \frac{1}{{σ}_{x} {σ}_{y}}$$

where μₓ and σₓ stand for the mean and standard deviation of the variable x, respectively, and x and y are both vectors of length m. This metric may be used as discrimination score for a question j by correlating the answer vector A(:, j) with the estimated student test scores s for those students who answered question j.

In the following, an example calculation is given where the index i stands for the i-th student who answered a respective question j, sⱼ contains only the student scores of students who answered question j, and A′ⱼ is a vector and derived from A in that A′ⱼ(i)=1 if student i answered question j correctly, or A′ⱼ(i)=0 if student i answered question j incorrectly. Notice that both A′ⱼ and sⱼ are vectors of length mₐ(j). The discrimination score of a question may be calculated as:

$${q}_{d} ( j ) = ( \frac{{A}_{j}^{′} {s}_{j}}{{m}_{a} ( j )} - f ( j ) {μ}_{{s}_{j}} ) \frac{1}{{σ}_{j} {σ}_{{s}_{j}}} \qquad ( 14 )$$

where ƒ(j) is the facility of a question (i.e. the mean correctness across all students or the fraction of students who got it correct in the dichotomous case:

$$f ( j ) = \frac{1}{{m}_{a} ( j )} {\sum }_{i} {A}_{j}^{′} ( i ) ,$$

and σⱼ is the standard deviation of the entries of vector A′ⱼ: σⱼ={square root over (ƒ(j)(1−ƒ(j)))}. These values may be updated in each iteration t for each question j:

$${{q}_{d} ( j )}^{( t )} ( \frac{{A}_{j}^{′} {s}_{j}^{( t )}}{{m}_{a} ( j )} - f ( j ) {μ}_{{s}_{j}^{( t )}} ) \frac{1}{{σ}_{j} {σ}_{{s}_{j}^{( t )}}} \qquad ( 15 )$$

Question scores. Question scores can be calculated by including various ways of correlating the question scores with discrimination scores:

q^{(t)}←ƒ_{q}(q_{d}^{(t)},A,s^{(t)}) (16)

Question scores can also be calculated directly from question discrimination scores, e.g., by taking a linear combination with the default question scores:

q^{(t)}←η_{d}q_{d}^{(t)}+(1−η_{d})q₀ (17)

Here, 0≦η_{d}≦1.

### 2.3 Question Part Version Weights

The question part version weights may be calculated as a function of the choices of the students who finalized the question and their respective student scores:

w_{j,k}^{(t)}←ƒ_{w}(F_{j,k},s_{j,k}^{(t)}) (18)

Here, s_{j,k} stands for the m_{ƒ}(j, k)-dimensional vector of the student scores of students who finalized part k of question j. In the following, an example calculation is given where the index i stands for the i-th student who finalized a respective question part.

First, an adapted finalize matrix F′_{j,k} may be created from F_{j,k} as follows: F′_{j,k}(i, l) may be set to

$$\frac{{υ}_{f} ( j , k , i ) - 1}{υ ( j , k )}$$

if F_{j,k}(i, l)=1 (i.e., student i selected version l), or

$$- \frac{1}{υ ( j , k )}$$

if F_{j,k}(i, l)=−1 (i.e., the student saw this version but did not select it), or 0 otherwise (i.e., the version was not shown to the student).

Second, a centered weight vector may be calculated for each question part by weighting the votes for each question with the score of the student who cast this vote and then normalize by dividing by the sum of all student scores:

$${w}_{j , k}^{′ ( t )} ← {F}_{j , k}^{⊤} {s}_{j , k}^{( t )} / {\sum }_{i} {s}_{j , k}^{( t )} ( i ) \qquad ( 19 )$$

By construction, the entries of the resulting vector are centered around 0, i.e. Σₗw′_{j,k}^{(t)}(l)=0, and the entries are between

$$- \frac{1}{υ ( j , k )} and \frac{υ ( j , k ) - 1}{υ ( j , k )} .$$

Third, the normalized weight vector w_{j,k}^{(t)} may be calculated by adding

$$\frac{1}{υ ( j , k )}$$

to each entry:

$${w}_{j , k}^{( t )} ( 𝓁 ) ← {w}_{j , k}^{′ ( t )} ( 𝓁 ) + \frac{1}{υ ( j , k )}$$

The resulting vector is normalized to 1, i.e. Σₗw_{j,k}^{(t)}(l)=1.

### FINALIZE EXAMPLE

Consider a part k of question j that has v(j, k)=5 versions and that is finalized by m_{ƒ}(j, k)=3 students. Student 1 sees versions 1, 2, 3 and selects the first one among the v_{ƒ}(j, k, l)=3 shown versions. Then

$${F}_{j , k} ( 1 , 1 ) = \frac{{υ}_{f} ( j , k , 1 ) - 1}{υ ( j , k )} = \frac{2}{5} , and$$

$${F}_{j , k} ( 1 , 2 ) = {F}_{j , k} ( 1 , 3 ) = - \frac{1}{υ ( j , k )} = - \frac{1}{5} .$$

Furthermore, student 2 sees all 5 versions and selects the first one as well. Student 3 sees versions 4 and 5 and selects 4. Then the full matrix F_{j,k} looks as follows:

$$\begin{matrix} & 𝓁 & & & & \\ & 1 & 2 & 3 & 4 & 5 \\ i 1 & \frac{2}{5} & - \frac{1}{5} & - \frac{1}{5} & & \\ 2 & \frac{4}{5} & - \frac{1}{5} & - \frac{1}{5} & - \frac{1}{5} & - \frac{1}{5} \\ 3 & & & & \frac{1}{5} & - \frac{1}{5}\end{matrix}$$

Next assume that the students 1, 2, 3 have scores s_{j,k}=(1, 1, 2)^{T}, respectively. Then,

$${F}_{j , k}^{⊤} {s}_{j , k} = {( \frac{6}{5 } , - \frac{2}{5} , - \frac{2}{5} , \frac{1}{5} , - \frac{3}{5} )}^{⊤} .$$

Sum of the student scores is Σᵢs_{j,k}(i)=4. Division leads to

$${( \frac{3}{10} , - \frac{1}{10} , - \frac{1}{10} , \frac{1}{20} , - \frac{3}{20} )}^{⊤}$$

which is the centered weight vector w′_{j,k}. Re-centering around ⅕ leads to the normalized weight vector w_{j,k}=(0.5, 0.1, 0.1, 0.25, 0.05)^{T}.

### 3. SEMI-SUPERVISED LEARNING

An example embodiment will now be described with additional trusted seed knowledge and semi-automatic approaches. In the semi-automatic extension of the above framework, an instructor is given the opportunity to add trusted information to the system. For example, the instructor can specify which students are more trusted, or which questions are of high quality, or which versions of a question are better. The system then propagates and spreads this trusted knowledge via the iterations to other items of unknown scores or weights (e.g., other students, or other questions provided by students, or other question part versions).

One simple method to achieve this is by explicitly setting the scores of certain questions or students, or the weight vectors of certain question parts, then not updating them in future iterations (hence, those scores are “fixed”). For example, the instructor can provide high quality questions from a trusted source such as a question bank from a text book, or questions created by an expert instructor and give those explicitly high discrimination values, or question scores. These questions can then be assigned to students in the same way as the student-generated questions.

Another example method to incorporate these questions into the set of r questions is as follows. The vector of default question scores q₀ may be allowed to have entries that represent the instructor's estimates of the quality of the n questions. This can be achieved by defining q₀=α1ₙ, i.e. each entry of the n-dimensional default question score vector has an entry where α(j)≦1. For the high quality seed questions, the a priori scores may be set to be the maximum possible value of 1. Thus, in the iterative update of the question quality scores in equation 17, the a priori quality values q₀ of only the seed questions remains at 1, while those of the student generated questions is a factor α lower. As a result of students answering these seed questions and over time, improving and finalizing them, these a priori quality values of the seed questions will propagate through the iterative updates to change the student quality scores and hence the question quality scores of the other questions created by students. For example, students who answer the seed questions correctly see the maximum possible increase in their answering quality, and hence their overall quality. These higher quality values propagate to higher values for the questions created by them, and also the improvements and finalizations done by them. The answers of these students also influence the discrimination quality scores q_{d} of other non-seed questions they answer, thus affecting the overall question quality scores for these questions. The framework may be extended to add high-quality seed questions and incorporate the interactions of the students with them to improve the scores of the students and the student-created questions. Similarly, the instructor can mark questions as bad (give them explicitly lower question scores).

In a similar vein, any form of ‘batched’ instructor input may be added in the system. Suppose that an instructor has gone over and answered, improved and finalized a set of questions in the system. The high quality of these inputs may be propagated by adding the instructor as a new “student” i* with very high student score values by default. As a heuristic, this value can be reset to a multiple (e.g., twice) the maximum score of any other real student in each iteration. Note that these “student scores” of instructors will not be updated in the iterative process in Equation 3. In other words, instructor i* may be set as:

$${s}^{( t )} ( {i}^{*} ) β {max}_{i ∈ [ m ]} {s}^{( t )} ( i ) \qquad ( 21 )$$

where β>1 is a large multiplier representing the proportionally higher authority or trust in the instructor versus a normal student (for example, β=2).

Another option for setting this value includes the following:

s^{(t)}(i*)←μ_{c}βs_{c}^{(t)}(*)+μₐβsₐ^{(t)}(*)+μᵢβsᵢ^{(t)}(*)+μ_{f}βs_{f}^{(t)}(*) (22)

where s_{c}^{(t)}(*):=max_{iε[m]}s_{c}^{(t)}(i) is the maximum create score of any student in this iteration, and the other max-scores are similarly defined, and the constant 3 represents the higher quality weight to instructor.

Notice any outside source that can be incorporated to better estimate any student score, any question score, or any question part version weight. For example, an instructor may upload seed questions together with prior determined question discrimination scores. Or, a participant in a course may have been independently assessed by a prior outside assessment. Or, higher default scores of some question part versions could be determined via automated text analysis. For example, some question version improvements that incorporate only minor changes (e.g., an added comma) may have, by default, a lower score than an improvement that creates a major text enhancement (e.g., text edit distance between after and before the improvement is bigger than 30% of the original text length).

In other words, each of the functions ƒₛ( ), ƒ_{c}( ), ƒₐ( ), ƒᵢ( ), ƒ_{ƒ}( ), ƒ_{q}( ), ƒ_{w}( ) can incorporate additional outside seed knowledge to better estimate certain seed values that push up or down (or fix) certain values. For example, let v(i) be any value and v(i)* be some outside estimate of this value. Then the actual value in iteration v(i)′^{(t)} could be calculated as linear combination of the otherwise updated value v(i)^{(t)} and the outside estimate v(i)*:

v(i)′^{(t)}←ηᵥv(i)^{(t)}+(1−ηᵥ)v(i)* (23)

### 4. EXAMPLE EMBODIMENT WITH ACTIVE LEARNING

In the above extension of the framework, the instructor may be allowed to specify trusted scores for certain items or students. In yet another extension of the framework, the system requests instructor input for items or students that it deems most useful to increase the confidence in its predictions may be allowed. This way, the system uses limited available instructor time to increase the overall quality of the student and question scores in the system in the best way possible.

The previous section demonstrated how to take into account the input given by the instructor (by regarding her as a special student with high score). The key question for actively surfacing relevant activities for the instructor to work on in limited time is the decision rule to decide about them. For example, this method gives a choice to instructors who want to engage with the system for limited time, to either answer, improve or finalize questions. Depending on her choice, a simple rule may be used to surface the most ambiguous questions currently in the system to answer, improve or finalize. Example ambiguity criteria for surfacing questions are as follows:

1. Answer ambiguity: One way is to surface questions with unusually high or low question characteristics. For example, the question which the largest number of students answered incorrectly may be selected. Other choices include the question for which the current question discrimination score q_{d}^{(t)}(•) is as small (negative) as possible.

2. Improve ambiguity: For example, the question may be picked for which the average number of new versions per part is the smallest. Other choices include the question for which the average fraction of times the parts were improved is the smallest.

3. Finalize ambiguity: Note that the question part version weight vector w′_{j,p} contains information about student choices among the various versions of these parts. A low variation among these values (especially among the top entries of the vector) implies that there is no clear winning version for the part. Thus, the question may be picked for which the average variance of the part version weight vectors is the lowest—this is the question for which there is overall low average agreement on the best versions. Other choices include the question for which the minimum or maximum of the variance of the part version weight vectors is the smallest.

These new expert student's input may be used in the equations to update the student and question quality scores. Given their high value of student scores, these finalizations will propagate the answers of the instructor into the student quality scores, and hence subsequently into the quality scores of the questions they create as in the case with seed questions. Thus the framework may be extended to actively seek instructor input on most ambiguous questions and incorporate this feedback to improve the scores of the students and the questions they create.

### 5. EXAMPLE ALTERNATIVE/ADDITIONAL EMBODIMENTS

In some instantiations, the question parts are not just stem, correct answer and several incorrect answers, but also additional “answer explanations” (giving reasoning behind correct or incorrect answers, for each of the answer choices) and “stem explanations” (giving overall explanations for the question).

In some instantiations, the actual answer selected by each student is used not only to calculate question discrimination scores but also “question answer discrimination scores” may be used for each of the discriminators. This allows different points to be given to two students (perhaps even negative points) who select two different incorrect answers.

In some instantiations, the above four phases are repeated several times and the resulting student scores are aggregated across several repetitions. Thus there are several assignments and student scores accumulate across those assignments.

In some instantiations, the above four phases are changed with another sequence of phases. For example, one could have several phases that improve the questions: (1) create phase: one student A creates one question. (2) answer and improve phase: another student B answers this question, then improves the question. (3) improve create phase: the original creator A of this question sees the improvement and updates the question based on the feedback. (4) answer phase: many other students answer the question. Both student A and student B get points based on the quality of the question that was created in the first two phases, e.g. 70% of the points go to student A and 30% of the points go to student B.

In some instantiations, the weight of a question part version is not just dependent on the students who selected this version in the finalize phase, but also on the quality score of the student who created this part during the improve phase. This allows the system to give higher default scores to improvements made by the student who performed better in other parts of the assessment.

In some instantiations, the number of questions that a student interacts with in an assignment part is chosen by the student. For example, a student may choose to only improve some of the questions presented to the student, or students may decide not to improve an already “perfect” question as the possible improvement would be only minor, whereas they may decide to improve other questions more carefully. Overall, this can create an improved use of the student time interacting with questions. In yet another example, a student may choose to create more or fewer questions on an assignment on a subject for which the student is more likely to be able to create good or bad questions, based on the student's familiarity with the subject. Depending on the intended incentives for students, the function ƒ_{c}( ) may be either convex or concave in the number of questions n_{c}(i) created by a student i rather than the linear version where it adds a fixed value α_{c} per contribution.

In some instantiations, a student has the option to improve a question after finalizing a given question. This can provide incentives to students who see, after seeing existing question part improvements, that the existing question versions can be further improved.

In some instantiations, the questions students submit are other forms of automatically gradable assessment items, for example, “choose all that apply.”

In some instantiations, the question quality scores are calculated for different question versions of the same question. For example, different subsets of students may be presented with different question versions (i.e. different combinations of question part versions) in the answering part (e.g., at the beginning of the answer and finalize phase). Different question versions may have different question discrimination scores which allows the system to determine better or worse (e.g., ambiguous) question part versions and their combinations.

In some instantiations, collusion across students can be detected via correlation analysis of pairs of students. For example, if student 1 always shares the correct answers to questions created by student 1 with another student 2, then there is a statistically significant correlation of student 2 being able to answer questions created by student 1. This may pose a problem in small classes where each student is likely to answer questions of each other student. The chosen functions ƒₛ( ), ƒ_{c}( ), ƒₐ( ), ƒᵢ( ), ƒ_{ƒ}( ), ƒ_{q}( ), ƒ_{w}( ) can be adapted to compensate for observed correlations.

In some instantiations, similarity between questions can be used to detect plagiarism. For example, every newly created question by a student can be automatically compared with shallow text analysis (e.g., bags of words) or deep natural language analysis (e.g., by using existing semantic parsers and synonym dictionar-ies) against previously stored question banks. The function ƒ_{c}( ) can be adopted to penalize students who created questions that are deemed to be similar to existing questions. This comparison can happen either by automatic analysis or by human inspection and comparison with existing questions.

In some instantiation, similarity between questions and prior performance by students can be used to decide which questions to show to which students. For example, if the system determines a set of questions that is considered to cover very similar topics, each of those questions may be shown only once to every student to avoid repeatedly testing similar topics. On the other hand, students who got certain questions wrong in the past may be shown other similar questions more often in the future to emphasize the same topic more than once.

In some instantiations, the numbers n_{c}(i), nₐ(i), nᵢ(i), and n_{f}(i) vary substantially between students. For example, one group of students may provide questions and another may answer questions. Students who perform different parts of the assignments are then only assessed by the quality of tasks they performed.

In some instantiations, student answer scores may be calculated by including the score of a student on their own submitted questions. Discrimination scores may be calculated by including or excluding the respective question in calculating the total test score.

In some instantiations, methods other than the point-biserial correlation coefficient can be used to determine question quality and determine question scores for the creator of questions. For example, variations of the Hubs and Authorities algorithm can be adapted to determine such scores.

In some instantiations, discrimination scores for student-submitted questions are determined only by the extent to which they predict students that successfully answer seed questions, i.e. those questions for which their high-quality is known. Similarly, answer scores by students may be calculated only based on how successfully they answer seed questions.

In some instantiations, ƒ_{q} and ƒ_{w} do not use the same questions scores s but rather use various other student assessments (see, e.g., FIG. 4). For example, ƒ_{q} may use sₐ only, whereas ƒ_{w} may use sᵢ and s_{c} together.

In some instantiations, the finalize part is repeated for a given student and a given question more than once. For example, the student may first answer a question and be presented with several screens on which the student has to finalize the same question several times, and each time with slightly different question part versions.

### 6. APPLYING THE IDEA OF BOOTSTRAPPED LEARNING CYCLES TO EVALUATING MORE GENERAL STUDENT-CREATED ARTIFACTS

In some instantiations, the above approach of propagating seed trusted knowledge can be applied not just for assessment items but for any type of student-created learning artifacts whose quality is correlated with the competence of the students who created them. In such application instances, the “create-answer” cycles that is specific to assessment items (left cycles in FIG. 4) cannot be used, however the “improvement-finalize” cycles (right cycles in FIG. 4) can still be used and bootstrapped with the help of trusted seed knowledge by the instructor or other outside knowledge. More generally, such a cycle connects “creating artifacts” with “selecting between different artifacts.”

Such “learning artifacts” can be, for example, essays, book summaries, short videos, drawings, jokes, creative designs, suggested constructions, code, or any other solutions to open-ended assignments whose relative quality is to be determined.

The key insight is the above-described “bootstrapping” with seed knowledge (semi-supervised learning) by providing ground truth data can be applied to these other forms of artifacts too. Seed knowledge can also come by declaring some individuals performing tasks in the system as trusted individuals (e.g., TAs or instructors) with higher and fixed student scores.

One important problem with current forms of peer evaluation is the appropriate alignment between student's motivation and the overall task. For example, a system that incentivizes students to create good artifacts (e.g., good essays) and then evaluates students based on how well they were evaluated on average by other students, needs some good incentives for the other students to provide both (a) truthful and (b) correct evaluations. Both (a) and (b) are separate problems. For example, a student may be (a) truthful, but does not have the skills to (b) adequately evaluate an artifact. As another example, a student may be able (b) to adequately evaluate an artifact, but (a) may not have the right incentives. For example, an incentive scheme that evaluates a student's evaluation based on how close the student's evaluation matches that of other students may incentivize students to not provide their truthful assessment, but rather their assessment of what all other students are voting (e.g., a student may discover a flaw in some artifact but may judge that other students are less likely to discover the same, and thus may be giving a higher evaluation than the student actually thinks is justified).

The present disclosure provides a method to use student's inputs in a way that creates both truthful and correct evaluations of items. For the case of assessment items, the problem of (a) truthful and (b) correct student evaluations may be solved by not having students vote on the quality of assessment items, but rather answer them as truthfully as possible (since they get points for answering good questions correctly), but “as a side-product” this interaction creates truthful evaluations of the quality of an assessment item (left “create-answer” cycle in FIG. 4).

For the case of creative learning artifacts, the problem of (a) truthful evaluations may be solved by inserting strategic and correct seed knowledge and using the method depicted in right “improvement-finalize” cycles in FIG. 4. This seed knowledge propagates throughout the system and adjusts values and votes for every other artifact weight and student score. For example, the good student who faces the dilemma of wanting to give an accurate assessment but fearing that the average student may disagree, is now more likely to vote accurately since the good student's vote counts more from the presence of adequate amount of correct seed knowledge in the system (not necessarily just for this artifact). Also, every particular question may have been resolved by a trusted individual which overwrites all votes by other students.

At the same time, the problem of (b) correct evaluations partially may be solved: since the input by various students is weighted differently, students who are more likely to give correct evaluations have higher impact on the aggregated evaluations.

### 6.1 Example Implementation

In the following example implementation, the right “improvement-finalize” cycles from FIG. 4 are focused on and the two respective steps are referred to as “creating artifacts” and “selecting between different artifacts” (newly depicted in FIG. 5). The necessary bootstrapping can come from any provided ground truth for any entries of the student scores (e.g., by identifying an individual to be a trusted individual like a TA) or by providing any weights between different learning artifacts (e.g., by identifying correct or subtly incorrect artifacts and adjusting their respective weights accordingly). In particular, FIG. 5 shows an example of a calculation of student assessment scores s by combining a “create” learning cycle with a “select” learning cycle: knowing w allows for calculation of s and vice versa. Additionally, knowing any entry of the displayed vector or tensor scores (s, s_{c}, sₛ, w) with higher certainty allows for propagation of this seed knowledge and for calculation of the remaining values with higher confidence.

### 6.1.1 Assignment Parts and Phases

(1) Create part. Each student i creates a set of n_{c}(i) artifacts. n=Σᵢn_{c}(i) may be used for the number of resulting artifacts. Vector i_{c} may be used where an entry i_{c}(j) refers to the student who created an artifact j.

(2) Select part. Each student i is shown mₛ(i) different subsets of artifacts. Let mₛ=Σᵢmₛ(i) be the total number of subsets shown to all students. For each such subset k of size nₛ(k) from the total n artifacts, the student i now selects one artifact. The subsets of artifacts seen by each student as well as the artifacts selected by each student can be recorded in a mₛ-dimensional vector iₛ where iₛ(k) is the index of the student who saw the k-th subset, together with a [mₛ×n]-dimensional finalization matrix F where F(k,j) is +1 if student iₛ(k) saw the k-th subset and selected artifact j, or −1 if artifact j was included in the k-th subset but was not selected by student iₛ(k), or 0 if the artifact was not included in the respective subset.

### 6.1.2 Semi-Automatic Scoring

(1) Create score. The create score for student i is defined as a function of the artifact weights for each of the artifacts created by the student:

s_{c}^{(t)}(i)←ƒ_{c}(i_{c},w^{(t-1)}) (24)

An example implementation is as follows:

$${s}_{c}^{( t )} ( i ) ← {\sum }_{j : created by i} ( {α}_{c} + {w}^{( t - 1 )} ( j ) ) \qquad ( 25 )$$

For the first iteration, s_{c}⁽¹⁾(i)=1 (except for the provided seed knowledge).

(2) Select score. The select score for student i is defined as a function of the subsets of artifacts the students have seen and the artifacts they have selected plus their respective weights:

sₛ^{(t)}(i)←ƒₛ(iₛ,F,w^{(t-1)}) (26)

An example implementation is as follows:

$${s}_{c}^{( t )} ( i ) ← {\sum }_{j : selected by i} ( {α}_{s} + {w}^{( t - 1 )} ( j ) ) \qquad ( 27 )$$

For the first iteration, sₛ⁽¹⁾(i)=1 (except for the provided seed knowledge).

(3) Artifact weight. The question part version weights may be calculated as a function of the choices of the students who finalized the question and their respective student scores:

w^{(t)}←ƒ_{w}(F,s^{(t)}) (28)

An example implementation is as follows: First, an adapted finalize matrix F′ from F may be created as follows: F′(k, j) is set to

$$\frac{{n}_{s} ( k ) - 1}{n}$$

if F(k, j)=1 (i.e., student iₛ(k) selected artifact j), or

$$- \frac{1}{n}$$

if F(k,j)=−1 (i.e., the student saw this artifact but did not select it), or 0 otherwise (i.e., the artifact was not part of the k-th subset).

Second, a centered weight vector may be calculated for all artifacts by weighting the votes for each question with the score of the student who cast this vote and then normalize by dividing by the sum of all student scores. In the following, let s′ be a mₛ-dimensional vector with repeated students scores such that s′(k):=s(j) with iₛ(k)=j:

$${w}^{′ ( t )} ← {F}^{⊤} {s}^{′ ( t )} / {\sum }_{k} {s}^{′ ( t )} ( k ) \qquad ( 29 )$$

Third, the normalized weight vector w^{(t)} may be calculated by adding

$$\frac{1}{n}$$

to each entry:

$${w}^{( t )} ( j ) ← {w}^{′ ( t )} ( j ) + \frac{1}{n} \qquad ( 30 )$$

The resulting vector is normalized to 1, i.e. Σⱼw^{(t)}(j)=1.

(4) Bootstrapping. An instructor is given the opportunity to add trusted information to the system. For example, the instructor can specify which students are more trusted, or which artifacts are of high quality. The system then propagates and spreads this trusted knowledge via the iterations to other items of unknown scores or weights (i.e. other students and other artifacts).

One simple way to achieve this is by explicitly setting the weights of certain artifacts or students, then not updating them in future iterations (hence, those scores or weights are “fixed”). For example, the instructor can provide high quality artifacts, or slightly defective artifacts. These questions can then be assigned to students in the same way as the student-generated questions. Another method is to explicitly fix the relative ranking between artifacts. For example, another weighting scheme would allow the trusted individual to specify that artifact 1 must have higher weights than 2 and 3 even though the respective weights are not fixed but are still updated in each iteration.

### 6.2 Other Variations

In some instantiations, the cycle between creating artifacts and selecting artifacts is bootstrapped by determining trusted individuals whose created artifacts, or whose selections have higher votes.

In some instantiations, the cycle between creating artifacts (e.g., improving questions) and selecting artifacts (e.g., finalizing different improvements) is bootstrapped by assigning scores based on automated analysis. For example, the quality of some artifacts can be determined based on automatic text analysis. Artifacts that use more sophisticated vocabulary, or that cover certain keywords that are used more rarely in other artifacts, or that are of high production quality, may have, by default, a higher score than others.

### 6.3 Particular Example Embodiments

A method of enabling semi-automated, interactive assessment of a plurality of individuals with respect to one or more subjects, the method performed by an assessment management system and comprising: displaying to each of the plurality of individuals a prompt for a specification of at least one creative artifact related to the one or more subjects; receiving a specification of at least one creative artifact related to the one or more subjects from each of the plurality of individuals; associating in at least one data structure the specification of at the least one creative artifact received from each of the plurality of individuals with each individual from which they were received; displaying to each respective one of the plurality of individuals at least two creative artifacts received from different ones from the plurality of individuals; receiving a selection of one creative artifact from among the different creative artifacts shown from each of the plurality of individuals; optionally receiving from a trusted individual a set of creative artifacts of high quality, a similarity to which can be used to determine a ranking among the artifacts received from the plurality of individuals; optionally seeding either the set of creative artifacts with known good artifacts or seeding the relative choices among artifacts by providing ground truth relative selections amongst such artifacts; determining at least one assessment result for each respective one of the plurality of individuals as a function of the at least one selection received from each respective one of the plurality of individuals and the high quality creative artifacts; determining an artifact quality for each creative artifact submitted by the non-trusted individuals as a function of a correlation between the assessment result for each of the plurality of individuals and the high quality creative artifacts; and generating and storing an overall assessment of each respective one of the plurality of individuals with respect to the one or more subjects as a function of the quality of the artifacts they created and their selections of creative artifacts shown to them.

In some embodiments, it may not be necessary to compare very different versions (e.g., different essays) but rather very specifically, different improvements of the same original artifact created by a student. The main difference to the described four assignment parts (create, answer, improve, and finalize) is that there is no answer part and that seed instructor knowledge is needed. For example, in some embodiments: students create some essays or artifacts; other students try to improve those (e.g., by improving a portion of an essay or artifact); other students choose among various improvements of the artifacts; seed knowledge is provided by including good improvements (e.g., by instructors providing good improvements), providing ground truth finalizations (e.g., by instructors choosing the best among some esssays or artifacts), and/or providing good (or high-scoring or trusted) individuals (e.g., the instructor either identifies good individuals or another learning cycle, such as creating and/or answering, provides some ground truth indications regarding which students are good students); then using some propagation scheme (such as the finalize weight score calculation above) to propagate seed knowledge and, e.g., qualities of individual student improvements, to determine relative student ranking or assessment.

### Exemplary Computing System

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web ap-pliance, a network router, a network switch, a network bridge, any machine capable of executing a sequence of instructions that specify an action to be taken by that machine, and any combinations thereof. In one example, a computing device may include and/or be included in a kiosk.

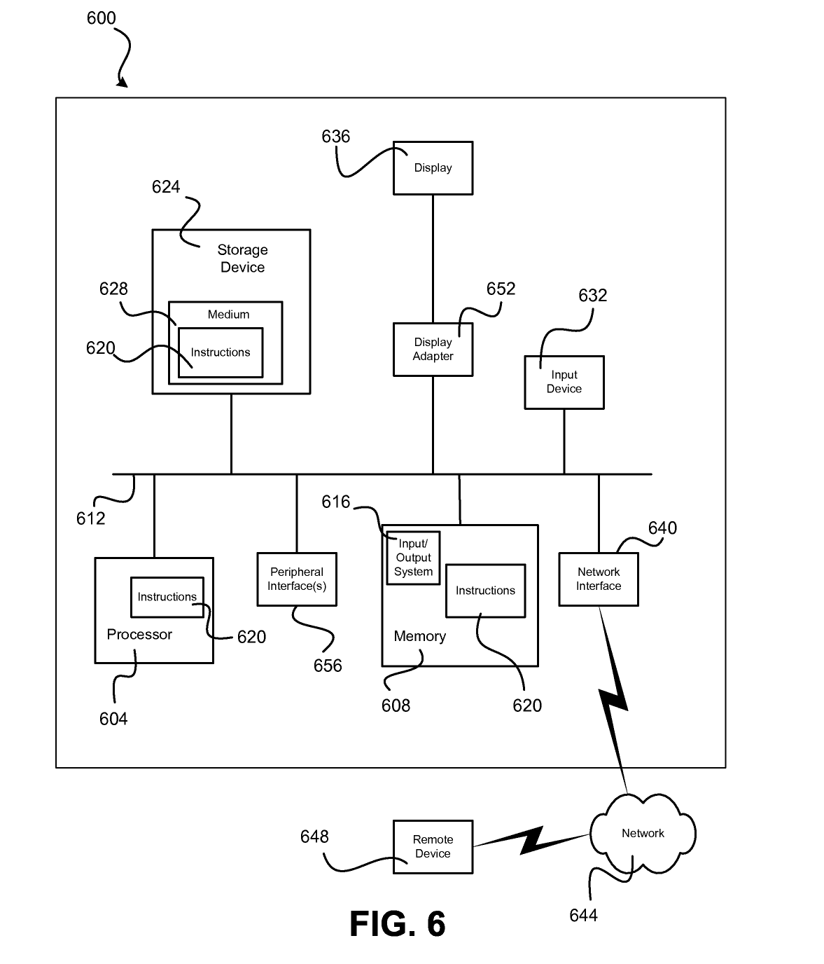

FIG. 6 shows a diagrammatic representation of one embodiment of a computing device in the exemplary form of a computer system 600 within which a set of instructions for causing one or more portions of a control system, such as the assessment management system system of FIG. 3, to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Memory 608 may include various components (e.g., machine-readable media) including, but not limited to, a random access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636.

Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

TABLE OF NOMENCLATURE

| | index | total |
|---|---|---|
| student | i | m |
| question | j | n |
| question part | k | p |
| question answer | k | a |
| question part version | l | v |

| | |
|---|---|
| q | n-dimensional vector of question (quality) scores. q(j) |
| q₀ | n-dimensional vector of question default scores |
| q_{d} | n-dimensional vector of question discrimination scores |
| s | m-dimensional vector of student (assignment) scores. s(i). |
| | Also: s_{c}, sₐ, sᵢ, s_{f} (created, answered, improved, finalized) |
| n_{c}(i) | number of questions created by student i. Also: nₐ, nᵢ, n_{f} |
| | (answered, improved, finalized) |
| mₐ(j) | number of students who answered question j |
| m_{f}(j, k) | number of students who finalized part k of question j |
| p(j) | number of parts for question j |
| a(j) | number of answers for question j. a(j) = p(j) − 1 |
| v(j, k) | number of versions of part k for question j |
| v_{f}(j, k, i) | number of versions of part k for question j that are shown to |
| | student i during the finalize phase |
| w_{j,k} | v(j, k)-dimensional vector of question part version weights |
| | for versions of part k for question j. w_{j,k}(l) |
| μ | weights for calculating students scores (μ_{c}, μₐ, μᵢ, μ_{f}) |
| (t) | index for iteration |
| A | [m × n]-dimensional answer matrix. A(i, j) ∈ {+1, 0, −1} |
| F_{j,k} | [m_{f}(j, k) × v(j, k)]-dimensional finalize matrix for part k of |
| | question j. F_{j,k}(i, l) ∈ {+1, 0, −1} |
| F_{j,k}′ | [m_{f}(j, k) × v(j, k)]-dimensional adapted finalize matrix for |
| | part k of question j. |
| | ${F}_{j , k}^{′} ( i , l ) ∈ \{ \frac{{v}_{f} ( j \text{,k,i} ) - 1}{v ( j \text{,} k )} , 0 , - \frac{1}{v ( \text{j,} k )} \}$ |
| η_{d} | mixing factor between discrimination scores and default |
| | scores |
| f(j) | facility of question j: percentage of students who answered |
| | question j and selected the correct question answer |
| σₛ_{ⱼ} | standard deviation of student scores among students who |
| | answered question j |
| σⱼ | standard deviation of correctness (0 or 1) for answers by |
| | students on question j: σⱼ = {square root over (f(j)(1 − f(j)))} |
| f( ) | transformation functions for which example |
| | implementations are given (see FIGS. 4 and 5) |

What is claimed is:

1. A method of enabling automated, interactive assessment of one or more of a plurality of untrusted individuals distributed across one or more networks with respect to one or more subjects, the method performed by an assessment management system and comprising:
displaying to one or more individuals of a first portion of the plurality of individuals a prompt for an assessment item including a specification related to the one or more subjects and one or more consistent responses and inconsistent responses to the specification;
receiving at least two assessment items from one or more individuals of the first portion of the plurality of individuals;
displaying to a first individual of a second portion of the plurality of individuals specifications of at least two assessment items received from at least one different individual of the plurality of individuals and prompts for responses to the specifications;
receiving responses to the specifications from the first individual;
displaying to a second individual of the second portion of the plurality of individuals specifications of at least two assessment items received from at least one different individual of the plurality of individuals and prompts for responses to the specifications, wherein the specifications of at least two assessment items displayed to the second individual are the specifications of at least two assessment items displayed to the first individual;
receiving responses to the specifications from the second individual;
determining an assessment result for each response received in response to each respective specification as a function of one or more of a consistent response and an inconsistent response to the respective specification received from the one or more individuals of the first portion of the plurality of individuals;
determining an assessment item quality for each respective assessment item as a function of a correlation between the assessment result for each response received in response to the specification of the assessment item from the first and second individuals and assessment results for responses received in response to a specification of at least one different respective assessment item from the first and second individuals; and
generating and storing an overall assessment of one or more individuals of the plurality of individuals with respect to the one or more subjects as a function of the assessment item quality for at least one assessment item either for which a specification was received from the individual or in response to the specification of which a response was received from the individual.

2. A method according to claim 1, further comprising storing one or more assessment items related to the one or more subjects in a bank of assessment items as a function of one or more of the assessment item quality for each assessment item and an overall assessment of one or more of the plurality of individuals.

3. A method according to claim 1, further comprising:
displaying to a trusted individual a prompt for an assessment item including a specification related to the one or more subjects and one or more consistent responses and inconsistent responses to the specification; and
receiving an assessment item from the trusted individual;
wherein displaying specifications of at least two assessment items to the first and second individuals of the second portion of the plurality of individuals includes displaying the assessment item received from the trusted individual to one or more of the first and second individuals.

4. A method according to claim 1, further comprising:
displaying an assessment item to an individual;
displaying to the individual a prompt for feedback regarding one or more of the specification of the assessment item, a consistent response to the specification, and an inconsistent response to the specification;
receiving feedback from the individual regarding one or more of the specification of the assessment item, a consistent response to the specification, and an inconsistent response to the specification; and
determining one or more of an assessment item quality for an assessment item and an overall assessment of one or more of the plurality of individuals as a function of the feedback from the individual.

5. A method according to claim 4, further comprising:
displaying the feedback to an individual;
displaying to the individual a prompt for additional feedback regarding the feedback;
receiving additional feedback regarding the feedback from the individual; and
determining one or more of an assessment item quality for an assessment item, a feedback quality of the feedback, and an overall assessment of one or more of the plurality of individuals as a function of the additional feedback.

6. A method according to claim 5, wherein said displaying the feedback to an individual includes displaying the feedback to an individual as a function of one or more of an assessment item quality for an assessment item, a confidence level of an assessment item quality for an assessment item, an assessment result, a confidence level of an assessment result, a feedback quality of the feedback, a confidence level of a feedback quality for the feedback, an overall assessment, and a confidence level of an overall assessment.

7. A method according to claim 4, wherein the individual is a trusted individual.

8. A method according to claim 7, wherein the trusted individual is an educator and the plurality of individuals are students.

9. A method according to claim 4, wherein said displaying an assessment item to an individual includes displaying an assessment item to the individual as a function of one or more of an assessment item quality for an assessment item, a confidence level of an assessment item quality for an assessment item, an assessment result, a confidence level of an assessment result, an overall assessment, and a confidence level of an overall assessment.

10. A method according to claim 9, wherein said displaying an assessment item to an individual includes displaying an assessment item to the individual as a function of an availability of the individual.

11. A method according to claim 10, wherein the individual is a trusted individual.

12. A method according to claim 1, wherein said receiving at least two assessment items from one or more individuals of the first portion of the plurality of individuals includes receiving one or more of a multiple choice, calculated formula, calculated numeric, either/or, matching, multiple answer, ordering, or true/false question.

13. A method according to claim 1, wherein determining an assessment item quality for each respective assessment item includes determining an assessment item quality for each respective assessment item as a function of an overall assessment of one or more individuals of the second portion of individuals.

14. A method of automatedly generating a bank of assessment items through automated, interactive assessment of one or more of a plurality of untrusted individuals distributed across one or more networks with respect to one or more subjects, the method performed by an assessment management system and comprising:
displaying to one or more individuals of a first portion of the plurality of individuals a prompt for an assessment item including a specification related to the one or more subjects and one or more consistent responses and inconsistent responses to the assessment item;
receiving at least two assessment items from one or more individuals of the first portion of the plurality of individuals;
displaying to a first individual of a second portion of the plurality of individuals specifications of at least two assessment items received from at least one different individual of the plurality of individuals and prompts for responses to the specifications;
receiving responses to the specifications from the first individual;
displaying to a second individual of the second portion of the plurality of individuals specifications of at least two assessment items received from at least one different individual of the plurality of individuals and prompts for responses to the specifications, wherein the specifications of at least two assessment items displayed to the second individual are the specifications of at least two assessment items displayed to the first individual;
receiving responses to the specifications from the second individual;
determining an assessment result for each response received in response to each respective specification as a function of one or more of a consistent response and an inconsistent response to the respective specification received from the one or more individuals of the first portion of the plurality of individuals;
determining an assessment item quality for each respective assessment item as a function of a correlation between the assessment result for each response received in response to the specification of the assessment item from the first and second individuals and assessment results for responses received in response to a specification of at least one different respective assessment item from the first and second individuals; and
storing one or more assessment items related to the one or more subjects in a bank of assessment items as a function of the assessment item quality for each assessment item.

15. A method according to claim 14, further comprising generating and storing an overall assessment of one or more individuals of the plurality of individuals with respect to the one or more subjects as a function of the assessment item quality for at least one assessment item either for which a specification was received from the individual or in response to the specification of which a response was received from the individual.

16. A method according to claim 15, wherein said storing one or more assessment items related to the one or more subjects in a bank of assessment items includes storing one or more assessments items related to the one or more subjects in a bank of assessment items as a function of an overall assessment of one or more of the plurality of individuals.

17. A method according to claim 15, wherein determining an assessment item quality for each respective assessment item includes determining an assessment item quality for each respective assessment item as a function of an overall assessment of one or more individuals of the second portion of individuals.

18. A method according to claim 14, further comprising:
displaying to a trusted individual a prompt for an assessment item including a specification related to the one or more subjects and one or more consistent responses and inconsistent responses to the specification; and
receiving an assessment item from the trusted individual;
wherein displaying specifications of at least two assessment items to the first and second individuals of the second portion of the plurality of individuals includes displaying the assessment item received from the trusted individual to one or more of the first and second individuals.

19. A method according to claim 14, further comprising:
displaying an assessment item to an individual;
displaying to the individual a prompt for feedback regarding one or more of the specification of the assessment item, a consistent response to the specification, and an inconsistent response to the specification;
receiving feedback from the individual regarding one or more of the specification of the assessment item, a consistent response to the specification, and an inconsistent response to the specification; and
determining one or more of an assessment item quality for an assessment item and an overall assessment of one or more of the plurality of individuals as a function of the feedback from the individual.

20. A method according to claim 19, further comprising:
displaying the feedback to an individual;
displaying to the individual a prompt for additional feedback regarding the feedback;
receiving additional feedback regarding the feedback from the individual; and
determining one or more of an assessment item quality for an assessment item, a feedback quality of the feedback, and an overall assessment of one or more of the plurality of individuals as a function of the additional feedback.

21. A method according to claim 20, wherein said displaying the feedback to an individual includes displaying the feedback to an individual as a function of one or more of an assessment item quality for an assessment item, a confidence level of an assessment item quality for an assessment item, an assessment result, a confidence level of an assessment result, a feedback quality of the feedback, a confidence level of a feedback quality for the feedback, an overall assessment, and a confidence level of an overall assessment.

22. A method according to claim 19, wherein the individual is a trusted individual.

23. A method according to claim 22, wherein the trusted individual is an educator and the plurality of individuals are students.

24. A method according to claim 19, wherein said displaying an assessment item to an individual includes displaying an assessment item to the individual as a function of one or more of an assessment item quality for an assessment item, a confidence level of an assessment item quality for an assessment item, an assessment result, a confidence level of an assessment result, an overall assessment, and a confidence level of an overall assessment.

25. A method according to claim 24, wherein said displaying an assessment item to an individual includes displaying an assessment item to the individual as a function of an availability of the individual.

26. A method according to claim 25, wherein the individual is a trusted individual.

27. A method according to claim 14, wherein said receiving at least two assessment items from one or more individuals of the first portion of the plurality of individuals includes receiving one or more of a multiple choice, calculated formula, calculated numeric, either/or, matching, multiple answer, ordering, or true/false question.
